(19) United States
(12) Patent Application Publication
(10) Pub. No.: US 2026/0267403 A1
(43) Pub. Date: Sep. 10, 2026

(54) System for Identifying and Generating Scents

(71) Applicant: SoftBank Group Corp., Tokyo (JP)

(72) Inventor: Tomohiko ARAI, Tokyo (JP)

(21) Appl. No.: 19/560,151

(22) Filed: Mar. 9, 2026

Related U.S. Application Data
(60) Provisional application No. 63/769,183, filed on Mar. 10, 2025.

(51) Int. Cl. G06F 3/01; G06F 3/04842

(52) U.S. Cl. CPC G06F 3/011; G06F 3/04842

(57) ABSTRACT

The present disclosure relates to a system that performs detailed identification and generation of a scent. A sensor unit detects a volatile organic compound and transmits data to an AI analysis unit of a server via a communication unit. The AI analysis unit analyzes the data using a machine learning algorithm and identifies a profile of a scent. A generation unit mixes a plurality of scent components in an appropriate ratio based on an instruction of AI, and generates a scent. A user interface unit enables selection of a scent and setting of generation timing through a smartphone application, and provides a scent experience according to a user's preference.

### CROSS-REFERENCE TO RELATED APPLICATION

This application claims the benefit of priority from U.S. Provisional Patent Application No. 63/769,183, filed on Mar. 10, 2025. The entire contents of the priority application are incorporated herein by reference.

### BACKGROUND

The technology of the present disclosure relates to a system.

Japanese Unexamined Patent Publication No. 2022-180282 discloses a persona chatbot control method performed by at least one processor, the method including the steps of receiving a user utterance, adding the said user utterance to a prompt including an instruction sentence related to a description of a character of a chatbot, encoding the said prompt, and inputting the said encoded prompt into a language model to generate a chatbot utterance responding to the said user utterance.

### SUMMARY

The problem to be solved by this disclosure is to overcome technical constraints in the identification and generation of scents. Specifically, with current technology, it is difficult to accurately identify chemical components of scents, and technology for reproducing specific scents is also limited. For this reason, it is difficult to identify scents in detail and generate scents at an arbitrary time or place according to a user's wish.

Furthermore, in the generation of scents, there is a problem that it is difficult to accurately adjust components of scents with related art methods, and as a result, it is not possible to provide reproducible scents. Also, an interface that allows a user to freely select a scent and adjust generation timing and intensity is lacking.

In order to solve these problems, this disclosure provides a technology that identifies components of scents in detail using a high-sensitivity sensor that detects volatile organic compounds, and accurately reproduces a specific scent by analyzing the data utilizing AI. Also, by providing an interface that allows a user to control selection of a scent and generation timing through a smartphone application, it makes it possible to perform generation of scents more freely and flexibly. In this way, the object is to overcome technical constraints in the identification and generation of scents and provide a new scent experience to a user.

As a means for solving the problem, the present disclosure provides a system that performs detailed identification and generation of a scent. This system includes a sensor unit for detecting a volatile organic compound and can detect chemical components in the air in real time. Data detected by the sensor unit is transmitted to an AI system on a cloud via a communication unit. This AI system analyzes the data using a machine learning algorithm and compares it with an existing scent database, thereby identifying a profile of the scent in detail.

Furthermore, the system includes a generation unit, and reproduces a specific scent based on the profile of the scent identified by the AI system. The generation unit uses a cartridge containing a plurality of scent components, mixes the components in an appropriate ratio in accordance with an instruction of the AI, and can generate a scent. Thereby, it becomes possible for a user to accurately reproduce a desired scent.

Also, a user interface unit is provided, and a user can perform selection of a scent, setting of generation timing, and adjustment of scent intensity through a smartphone application. By this interface, a user can freely control generation of a scent and enjoy the scent at an arbitrary time and place. In this way, the present disclosure overcomes technical constraints in the identification and generation of scents and realizes a means for providing a new scent experience to a user.

### BRIEF DESCRIPTION OF DRAWINGS

FIG. 1 is a conceptual diagram showing an example of a configuration of a data processing system according to a first embodiment.

FIG. 2 is a conceptual diagram showing an example of main functional parts of a data processing apparatus and a smart device according to the first embodiment.

FIG. 3 is a conceptual diagram showing an example of a configuration of a data processing system according to a second embodiment.

FIG. 4 is a conceptual diagram showing an example of main functional parts of a data processing apparatus and smart glasses according to the second embodiment.

FIG. 5 is a conceptual diagram showing an example of a configuration of a data processing system according to a third embodiment.

FIG. 6 is a conceptual diagram showing an example of main functional parts of a data processing apparatus and a headset-type terminal according to the third embodiment.

FIG. 7 is a conceptual diagram showing an example of a configuration of a data processing system according to a fourth embodiment.

FIG. 8 is a conceptual diagram showing an example of main functional parts of a data processing apparatus and a robot according to the fourth embodiment.

FIG. 9 shows an emotion map on which a plurality of emotions are mapped.

FIG. 10 shows an emotion map on which a plurality of emotions are mapped.

FIG. 11 is a flowchart illustrating an example of a method for blending a fragrance.

### DETAILED DESCRIPTION

Hereinafter, an example of an embodiment of a system according to the technology of the present disclosure will be described in accordance with the accompanying drawings.

First, terms used in the following description will be described.

In the following embodiments, a processor with a reference numeral (hereinafter, simply referred to as a “processor”) may be one arithmetic unit or may be a combination of a plurality of arithmetic units. Also, the processor may be one type of arithmetic unit or may be a combination of a plurality of types of arithmetic units. Examples of the arithmetic unit include a CPU (Central Processing Unit), a GPU (Graphics Processing Unit), a GPGPU (General-Purpose computing on Graphics Processing Units), an APU (Accelerated Processing Unit), and the like.

In the following embodiments, a RAM (Random Access Memory) with a reference numeral is a memory in which information is temporarily stored, and is used as a work memory by the processor.

In the following embodiments, a storage with a reference numeral is one or a plurality of non-volatile storage devices that store various programs, various parameters, and the like. Examples of the non-volatile storage device include a flash memory (SSD (Solid State Drive)), a magnetic disk (for example, a hard disk), a magnetic tape, or the like.

In the following embodiments, a communication I/F (Interface) with a reference numeral is an interface including a communication processor, an antenna, and the like. The communication I/F manages communication between a plurality of computers. Examples of communication standards applied to the communication I/F include wireless communication standards including 5G (5th Generation Mobile Communication System), Wi-Fi (Registered Trademark), Bluetooth (Registered Trademark), or the like.

In the following embodiments, “A and/or B” is synonymous with “at least one of A and B”. That is, “A and/or B” means that it may be only A, may be only B, or may be a combination of A and B. Also, in this specification, when three or more matters are expressed by connecting them with “and/or”, the same concept as “A and/or B” applies.

### First Embodiment

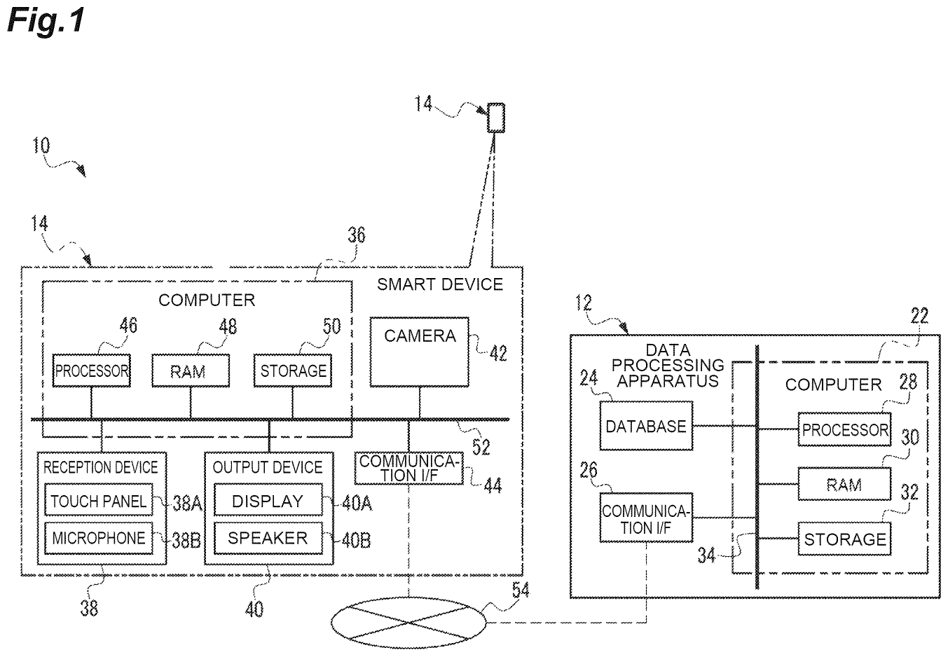

FIG. 1 shows an example of a configuration of a data processing system 10 according to a first embodiment.

As shown in FIG. 1, the data processing system 10 includes a data processing apparatus 12 and a smart device 14. An example of the data processing apparatus 12 includes a server.

The data processing apparatus 12 includes a computer 22, a database 24, and a communication I/F 26. The computer 22 is an example of a “computer” according to the technology of the present disclosure. The computer 22 includes a processor 28, a RAM 30, and a storage 32. The processor 28, the RAM 30, and the storage 32 are connected to a bus 34. Also, the database 24 and the communication I/F 26 are also connected to the bus 34. The communication I/F 26 is connected to a network 54. Examples of the network 54 include a WAN (Wide Area Network) and/or a LAN (Local Area Network), and the like.

The smart device 14 includes a computer 36, a reception device 38, an output device 40, a camera 42, and a communication I/F 44. The computer 36 includes a processor 46, a RAM 48, and a storage 50. The processor 46, the RAM 48, and the storage 50 are connected to a bus 52. Also, the reception device 38, the output device 40, and the camera 42 are also connected to the bus 52.

The reception device 38 includes a touch panel 38A, a microphone 38B, and the like, and receives a user input. The touch panel 38A receives a user input by contact of an indicator by detecting contact of the indicator (for example, a pen or a finger, etc.). The microphone 38B receives a user input by voice by detecting the voice of a user. A control unit 46A transmits data indicating the user input received by the touch panel 38A and the microphone 38B to the data processing apparatus 12. In the data processing apparatus 12, a specific processing unit 290 acquires the data indicating the user input.

The output device 40 includes a display 40A, a speaker 40B, and the like, and presents data to a user 20 by outputting the data in a representation form perceivable by the user 20 (for example, audio and/or text). The display 40A displays visible information such as text and images in accordance with an instruction from the processor 46. The speaker 40B outputs audio in accordance with an instruction from the processor 46. The camera 42 is a small digital camera on which an optical system such as a lens, a diaphragm, and a shutter, and an imaging element such as a CMOS (Complementary Metal-Oxide-Semiconductor) image sensor or a CCD (Charge Coupled Device) image sensor are mounted.

The communication I/F 44 is connected to the network 54. The communication I/Fs 44 and 26 manage exchange of various information between the processor 46 and the processor 28 via the network 54.

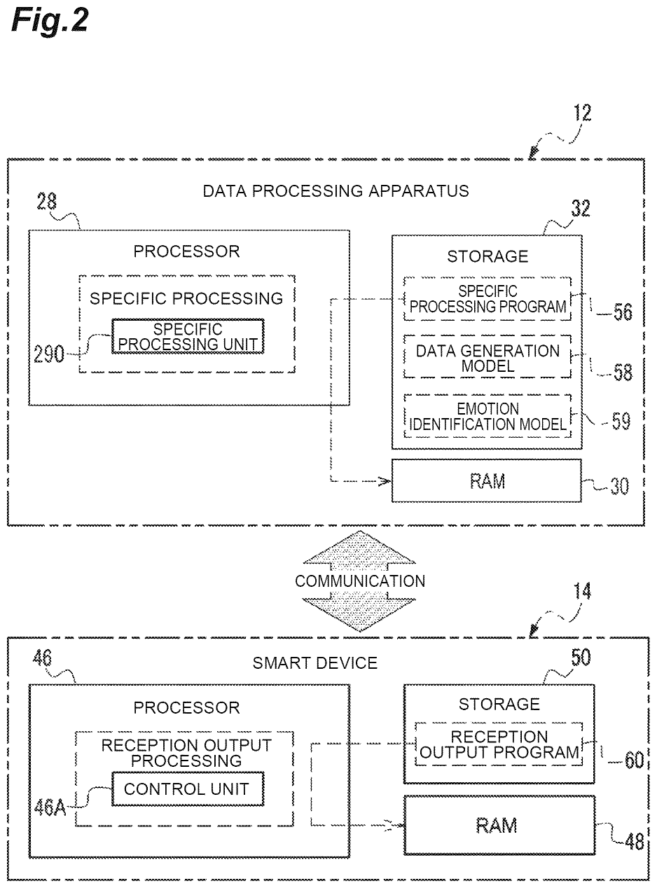

FIG. 2 shows an example of main functional parts of the data processing apparatus 12 and the smart device 14.

As shown in FIG. 2, in the data processing apparatus 12, specific processing is performed by the processor 28. A specific processing program 56 is stored in the storage 32. The specific processing program 56 is an example of a “program” according to the technology of the present disclosure. The processor 28 reads the specific processing program 56 from the storage 32 and executes the read specific processing program 56 on the RAM 30. The specific processing is realized by the processor 28 operating as the specific processing unit 290 in accordance with the specific processing program 56 executed on the RAM 30.

A data generation model 58 and an emotion identification model 59 are stored in the storage 32. The data generation model 58 and the emotion identification model 59 are used by the specific processing unit 290. The specific processing unit 290 can estimate an emotion of the user using the emotion identification model 59 and perform specific processing using the emotion of the user. In an emotion estimation function (emotion identification function) using the emotion identification model 59, various estimations and predictions regarding the emotion of the user, including estimation and prediction of the emotion of the user, are performed, but it is not limited to such an example. Also, the estimation and prediction of the emotion include, for example, analysis (analytics) of the emotion and the like.

In the smart device 14, reception output processing is performed by the processor 46. A reception output program 60 is stored in the storage 50. The reception output program 60 is used in combination with the specific processing program 56 by the data processing system 10. The processor 46 reads the reception output program 60 from the storage 50 and executes the read reception output program 60 on the RAM 48. The specific processing is realized by the processor 46 operating as the control unit 46A in accordance with the specific processing program 60 executed on the RAM 48. Note that the smart device 14 may have a data generation model and an emotion identification model similar to the data generation model 58 and the emotion identification model 59, and may perform processing similar to that of the specific processing unit 290 using these models. The reception output processing is realized by the processor 46 operating as the control unit 46A in accordance with the reception output program 60 executed on the RAM 48.

Note that an apparatus other than the data processing apparatus 12 may have the data generation model 58. For example, a server apparatus (for example, a generation server) may have the data generation model 58. In this case, the data processing apparatus 12 obtains a processing result (prediction result, etc.) using the data generation model 58 by communicating with the server apparatus having the data generation model 58. Also, the data processing apparatus 12 may be a server apparatus, or may be a terminal apparatus possessed by a user (for example, a mobile phone, a robot, a home appliance, etc.). Next, an example of processing by the data processing system 10 according to the first embodiment will be described.

### EXAMPLE 1

A flow of specific processing in Example 1 will be described. Each part of the system described below is realized by the data processing apparatus 12 and the smart device 14. Also, the data processing apparatus 12 is referred to as a “server”, and the smart device 14 is referred to as a “terminal”.

### Embodiment

An embodiment will be described more specifically and in detail.

First, regarding the sensor unit for performing detailed identification of a scent. The sensor unit may be configured by, for example, the reception device 38. For example, although there is no disclosure of the sensor unit in FIG. 1, for example, the reception device 38 may include it as, for example, a sensor unit 38C. This sensor unit is built into the terminal and includes a high-sensitivity sensor for detecting a volatile organic compound. This sensor can use technologies such as, for example, a semiconductor gas sensor, an optical sensor, or a mass spectrometry sensor. Thereby, it is possible to detect trace chemical substances in the air in real time in an office, in a home, and further in a public place. The sensor converts detected chemical components into electrical signals and processes them as digital data. This data is transmitted to the server via the communication unit (communication I/F 44) in the terminal.

The sensor unit is configured to include an array of semiconductor gas sensors (Metal Oxide Semiconductor: MOS) having a plurality of different sensitivity characteristics or a quartz crystal microbalance (QCM) sensor. Each sensor element outputs a change in electrical resistance value or a frequency change when a specific volatile organic compound (VOC) molecule is adsorbed as an analog signal. For example, the processor 46 A/D converts time-series analog signals obtained from these plurality of sensor elements, applies a noise removal filter (for example, a Kalman filter or a moving average filter), and then generates a multidimensional “scent feature vector (Scent Feature Vector)”. This feature vector is not the “smell” itself perceived by humans, but digital data indicating a response pattern unique to the sensor, and functions as input data to a machine learning model by an AI analysis unit described later.

By this processing, differences in trace chemical components that cannot be distinguished by human olfaction and changes in scent over time (change from top note to base note, etc.) are converted into a quantitative data structure that can be processed by a computer. This is not merely collection of information, but a technical process of converting a physical chemical phenomenon into a specific electrical signal pattern.

Next, regarding the AI system arranged on the server. The AI system may be configured by, for example, the specific processing unit 290, the specific processing program 56, the data generation model 58, and the emotion identification model 59. This AI system analyzes chemical component data transmitted from the terminal using a machine learning algorithm. Specifically, it identifies a profile of a scent in detail by utilizing deep learning technology and comparing it with an existing scent database. In this database, chemical characteristics of various scents such as, for example, a scent of a flower, a scent of a fruit, a scent of a spice, a scent of wood, and further an artificial scent are registered. The AI system identifies a specific scent based on these data and analyzes its component composition. For example, when identifying a scent of a rose, it identifies a combination of a specific floral component and a component having sweetness.

The AI system (specific processing unit 290) includes a neural network (for example, a convolutional neural network (CNN) or a Transformer model) that takes the received scent feature vector as input and outputs a specific scent ID or component composition ratio. This model is pre-learned using a teacher data set including pairs of known chemical component data and corresponding sensor response patterns.

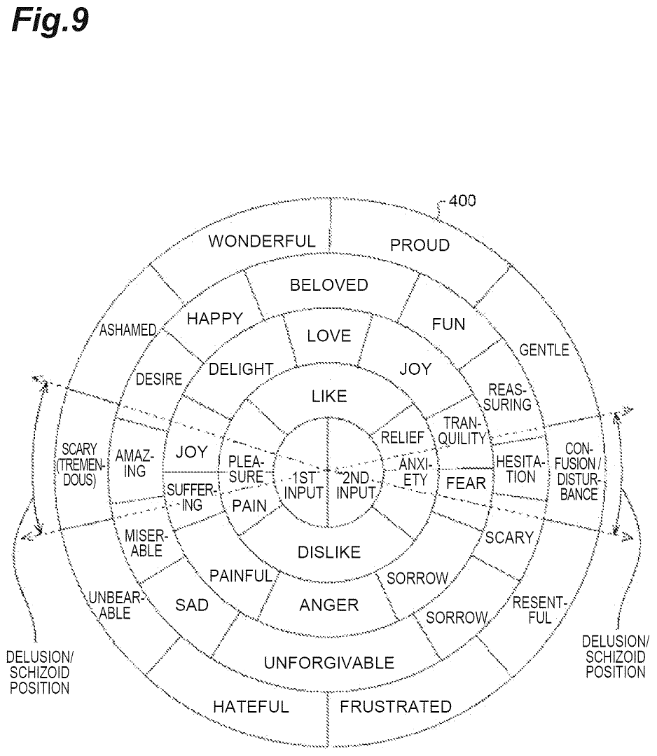

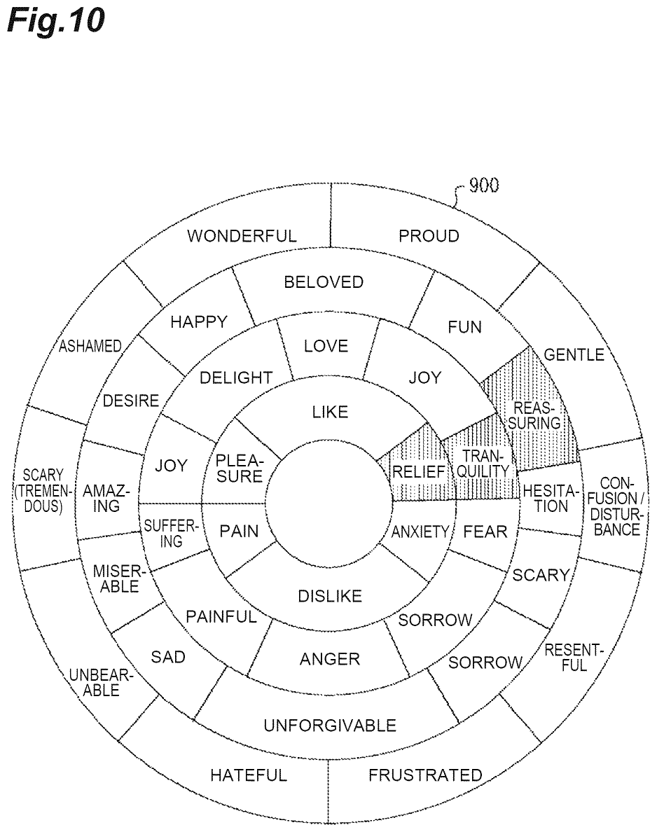

Specifically, the AI system maps the input feature vector to a latent space (Latent Space) and identifies the scent by calculating the Euclidean distance or cosine similarity with a reference profile in the database 24. Furthermore, the AI system may cooperate with the emotion maps 400 and 900 shown in FIG. 9 or FIG. 10 to calculate an “emotion influence score” that predicts the influence of the detected scent on the user's emotion. For example, when the detected scent is “lavender”, it is determined that the transition probability from “ANXIETY” to “RELIEF” on the emotion map is high.

Regarding generation of a scent, the generation unit is mounted on the terminal. The generation unit may be configured by, for example, the output device 40. For example, although there is no disclosure of the generation unit in FIG. 1, for example, the output device 40 may include it as, for example, a generation unit 40C. This generation unit includes a cartridge containing a plurality of scent components, and instructs which component is to be mixed in what ratio based on the profile of the scent identified by the AI system. For example, when reproducing a scent of a rose, a scent desired by a user can be generated by mixing a specific floral component and a component having sweetness in an appropriate ratio. The generation unit releases the scent by heating or vaporizing a liquid or solid scent component. At this time, in order to adjust intensity or duration of the scent, concentration or vaporization speed of the component can be controlled.

The generation unit includes a plurality of scent cartridges (for example, three primary colors of scents corresponding to cyan, magenta, and yellow, or base, middle, and top note components) and a micropump or a piezo element that controls the discharge amount of each cartridge. For example, although there is no disclosure of the cartridge, the micropump, and the piezo element in FIG. 1, for example, the output device 40 may include them as, for example, a cartridge 40D, a micropump 40E, and a piezo element 40F. The processor 46 performs PWM (Pulse Width Modulation) control on the drive duty ratio (Duty Cycle) or voltage of each micropump based on “scent recipe data (component blending ratio)” received from the AI system.

Furthermore, the generation unit may execute a feedback control loop. That is, the generated scent is detected again by the sensor unit, and an error (Error) with the target scent profile is calculated. The processor corrects the blending ratio in real time so that this error becomes equal to or less than a predetermined threshold (PID control, etc.). Thereby, changes in scent due to environmental factors (temperature, humidity, airflow) are compensated for, and the intended scent is accurately reproduced.

Furthermore, the user interface unit is mounted on the terminal and realized as a smartphone application. The user interface unit may be configured by, for example, the reception device 38, the output device 40, and the communication I/F 44. This application provides an interface for a user to perform selection of a scent, setting of generation timing, and adjustment of scent intensity. For example, a user can set to generate a scent of lavender at a relaxation time in the morning, or select a scent of mint to enhance concentration during work, through the application. Also, by adjusting the intensity of the scent, it is possible to change concentration of the scent spreading throughout a room in accordance with the user's preference. Furthermore, the application can record a history of scents and make a proposal of a scent based on the user's preference or past selection.

In this way, the present disclosure provides a system that efficiently performs detailed identification and generation of a scent by combining a server and a terminal. This system enables a user to enjoy a scent at an arbitrary time and place, and raises a scent experience to a new dimension. Furthermore, the system has expandability, and by adding a new scent database, identification and generation of more diverse scents become possible. Thereby, a user can enjoy a customized scent experience according to individual needs.

### System Configuration

The system according to the present embodiment includes a sensor unit, a communication unit, an AI analysis unit, a generation unit, and a user interface unit.

The sensor unit includes a high-sensitivity sensor for detecting a volatile organic compound, and technologies such as, for example, a semiconductor gas sensor, an optical sensor, and a mass spectrometry sensor can be used. This sensor unit can detect trace chemical substances in the air in real time in an office, in a home, and further in a public place. Specifically, it can detect various chemical components such as, for example, floral components constituting a scent of a flower, esters constituting a scent of a fruit, terpenes constituting a scent of a spice, and phenols constituting a scent of wood. Thereby, the sensor unit provides basic data for forming a detailed profile of a scent.

The communication unit plays a role of transmitting data detected by the sensor unit to the server. This communication unit can transmit data from the terminal to the server quickly and reliably using wireless communication technology such as Wi-Fi or Bluetooth. For example, data detected by the sensor unit can be transmitted to the AI analysis unit on the cloud utilizing a Wi-Fi network in a home. Also, it is possible to perform data transfer at a short distance using Bluetooth. Furthermore, the communication unit includes encryption and authentication functions for data, and secures security of transmitted data.

The AI analysis unit is arranged on the server and analyzes chemical component data transmitted from the communication unit. This AI analysis unit uses a machine learning algorithm to compare data with an existing scent database and identifies a profile of a scent in detail. For example, it can analyze chemical characteristics of various scents such as a scent of a flower, a scent of a fruit, a scent of a spice, a scent of wood, and further an artificial scent by utilizing deep learning technology. The AI analysis unit identifies a specific scent based on these data and analyzes its component composition. Specifically, when identifying a scent of a rose, it is possible to identify a combination of a specific floral component and a component having sweetness.

The generation unit is mounted on the terminal and reproduces a specific scent based on the profile of the scent identified by the AI analysis unit. This generation unit includes a cartridge containing a plurality of scent components, mixes the components in an appropriate ratio in accordance with an instruction of the AI, and can generate a scent. For example, when reproducing a scent of a rose, a scent desired by a user can be generated by mixing a specific floral component and a component having sweetness in an appropriate ratio. The generation unit releases the scent by heating or vaporizing a liquid or solid scent component. At this time, in order to adjust intensity or duration of the scent, concentration or vaporization speed of the component can be controlled.

The user interface unit is mounted on the terminal and realized as a smartphone application. This application provides an interface for a user to perform selection of a scent, setting of generation timing, and adjustment of scent intensity. For example, a user can set to generate a scent of lavender at a relaxation time in the morning, or select a scent of mint to enhance concentration during work, through the application. Also, by adjusting the intensity of the scent, it is possible to change concentration of the scent spreading throughout a room in accordance with the user's preference. Furthermore, the application can record a history of scents and make a proposal of a scent based on the user's preference or past selection.

Specific examples of prompt sentences to be read by the generative AI necessary when implementing the present disclosure include “Please tell me the ratio of floral components and components having sweetness necessary to reproduce the scent of a rose” and “Please propose an optimal component composition for generating the scent of lavender”. By using these prompt sentences, the AI can perform generation of a scent according to a user's request.

### Implementation Steps

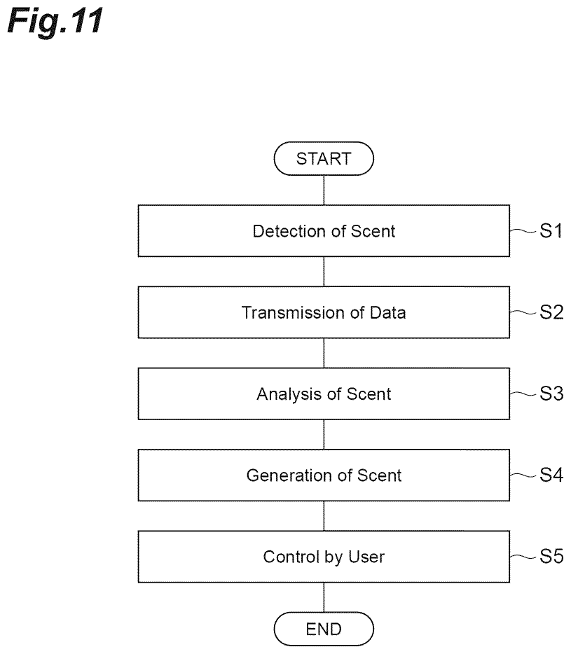

### Step 1: Detection of Scent (See Step S1 in FIG. 11)

Detection of a scent is performed by the sensor unit mounted on the terminal. This sensor unit includes a high-sensitivity sensor for detecting a volatile organic compound, and for example, a semiconductor gas sensor or an optical sensor can be used. Thereby, it is possible to detect trace chemical substances in the air in real time in an office, in a home, and further in a public place. Specifically, it is possible to detect various chemical components such as floral components constituting a scent of a flower and esters constituting a scent of a fruit.

### Step 2: Transmission of Data (See Step S2 in FIG. 11)

Detected chemical component data is transmitted to the server via the communication unit in the terminal. This communication unit transmits data quickly and reliably using wireless communication technology such as Wi-Fi or Bluetooth. For example, data detected by the sensor unit can be transmitted to the AI analysis unit on the cloud utilizing a Wi-Fi network in a home. The communication unit includes encryption and authentication functions for data, and secures security of transmitted data.

### Step 3: Analysis of Scent (See Step S3 in FIG. 11)

The AI analysis unit on the server analyzes the chemical component data transmitted from the communication unit. This AI analysis unit uses a machine learning algorithm to compare data with an existing scent database and identifies a profile of a scent in detail. For example, it can analyze chemical characteristics of various scents such as a scent of a flower, a scent of a fruit, and a scent of a spice by utilizing deep learning technology. A specific example of a prompt sentence to be read by the generative AI includes “Please tell me the ratio of floral components and components having sweetness necessary to reproduce the scent of a rose”.

### Step 4: Generation of Scent (See Step S4 in FIG. 11)

The generation unit reproduces a specific scent based on the profile of the scent identified by the AI analysis unit. This generation unit includes a cartridge containing a plurality of scent components, mixes the components in an appropriate ratio in accordance with an instruction of the AI, and can generate a scent. For example, when reproducing a scent of a rose, a scent desired by a user can be generated by mixing a specific floral component and a component having sweetness in an appropriate ratio. The generation unit releases the scent by heating or vaporizing a liquid or solid scent component.

### Step 5: Control by User (See Step S5 in FIG. 11)

The user interface unit is mounted on the terminal and realized as a smartphone application. This application provides an interface for a user to perform selection of a scent, setting of generation timing, and adjustment of scent intensity. For example, a user can set to generate a scent of lavender at a relaxation time in the morning, or select a scent of mint to enhance concentration during work, through the application. Also, by adjusting the intensity of the scent, it is possible to change concentration of the scent spreading throughout a room in accordance with the user's preference.

### Specific Use Case

For example, consider a case where a scent is utilized to create a relaxed atmosphere in a living room in a certain home. In this home, the terminal is installed in the living room, and the sensor unit detects chemical components in the air. The sensor unit detects volatile organic compounds in real time and transmits the data to the AI analysis unit of the server via the communication unit.

The AI analysis unit compares the received data with the existing scent database in order to identify a scent suitable for the living room based on the data. For example, when selecting a scent of lavender having a relaxation effect, the AI analyzes a combination of floral components and herbal components and generates an optimal scent profile. At this time, a specific example of a prompt sentence to be read by the generative AI includes “Please tell me the components and their ratio necessary to generate a scent of lavender for enhancing a relaxation effect in a living room”.

The generation unit mixes components necessary to reproduce the scent of lavender from the cartridge in an appropriate ratio based on an instruction from the AI analysis unit. The generation unit releases the scent by heating or vaporizing a liquid or solid scent component so that it spreads throughout the living room. Thereby, the family can spend time in a relaxed atmosphere.

The user interface unit is provided as a smartphone application, and a user can perform selection of a scent and setting of generation timing through the application. For example, it is possible to set a schedule to generate a scent of lavender in accordance with a relaxation time in the evening, or adjust the intensity of the scent to change concentration of the scent spreading throughout the room in accordance with preference. Furthermore, the application can record a history of scents and make a proposal of a new scent based on the user's preference or past selection.

In this way, the present disclosure can provide a new experience to a user and improve quality of daily life through utilization of scents in a home. Specific examples of prompt sentences to be read by the generative AI include “Please propose an optimal combination of scents for a relaxation time in the evening” and “Please perform component adjustment for emphasizing the scent of lavender”. Thereby, the AI can perform generation of a scent according to a user's request.

### APPLICATION EXAMPLE 1

A flow of specific processing in Application Example 1 will be described. Each part of the system described below is realized by the data processing apparatus 12 and the smart device 14. Also, the data processing apparatus 12 is referred to as a “server”, and the smart device 14 is referred to as a “terminal”.

### Embodiment

An embodiment will be described more specifically and in detail.

The present disclosure is a relaxation system using scents in a nursing care facility, and includes a sensor unit, a communication unit, an AI analysis unit, a generation unit, and a user interface unit. This system aims to reduce stress of users and provide a comfortable environment.

First, the sensor unit will be described in detail. The sensor unit is installed in each room or common space in the facility and includes a high-sensitivity sensor for detecting a volatile organic compound. This sensor can use technologies such as, for example, a semiconductor gas sensor, an optical sensor, or a mass spectrometry sensor. Thereby, it is possible to detect trace chemical substances in the air in the facility in real time. Specifically, it is possible to select a scent of lavender having a relaxation effect during a time zone when users take a nap, and select a citrus-based scent that stimulates appetite during a meal time zone. Also, it is possible to collect data for selecting an appropriate scent in accordance with activity status of users or an environment in the facility. For example, it is possible to select an optimal scent by combining data such as temperature and humidity in the facility, and heart rate and activity amount of users.

Next, the communication unit will be described in detail. The communication unit plays a role of transmitting data detected by the sensor unit to the AI analysis unit of the server. This communication unit can transmit data quickly and reliably using wireless communication technology such as Wi-Fi or Bluetooth. For example, data detected by the sensor unit can be transmitted to the AI analysis unit on the cloud utilizing a Wi-Fi network in a home. Also, it is possible to perform data transfer at a short distance using Bluetooth. Furthermore, the communication unit includes encryption and authentication functions for data, and secures security of transmitted data. Thereby, accurate transmission of data becomes possible while protecting privacy of users.

The AI analysis unit is arranged on the server and analyzes chemical component data transmitted from the communication unit. This AI analysis unit uses a machine learning algorithm to compare data with an existing scent database and identifies a profile of a scent in detail. For example, it can analyze chemical characteristics of various scents such as a scent of a flower, a scent of a fruit, a scent of a spice, a scent of wood, and further an artificial scent by utilizing deep learning technology. The AI analysis unit identifies a specific scent based on these data and analyzes its component composition. Specifically, when identifying a scent of a rose, it is possible to identify a combination of a specific floral component and a component having sweetness. Also, the AI analysis unit can consider selection history of past scents and preferences of users, and propose an optimal scent for each individual user.

The generation unit is mounted on the terminal and reproduces a specific scent based on the profile of the scent identified by the AI analysis unit. This generation unit includes a cartridge containing a plurality of scent components, mixes the components in an appropriate ratio in accordance with an instruction of the AI, and can generate a scent. For example, when reproducing a scent of a rose, a scent desired by a user can be generated by mixing a specific floral component and a component having sweetness in an appropriate ratio. The generation unit releases the scent by heating or vaporizing a liquid or solid scent component. At this time, in order to adjust intensity or duration of the scent, concentration or vaporization speed of the component can be controlled. Furthermore, the generation unit can cooperate with an air conditioning system in the facility to diffuse the scent efficiently.

The user interface unit is mounted on the terminal and realized as a smartphone application. This application provides an interface for staff of the facility to perform selection of a scent and setting of generation timing. The staff can control generation of a scent in accordance with a state of a user or a situation in the facility. For example, it is possible to set a schedule to generate a scent in accordance with a time zone when a user feels like relaxing, or adjust the intensity of the scent to change concentration of the scent spreading in the facility. Also, the interface can record a history of scents and make a proposal of a new scent based on a user's preference or past selection. Furthermore, the application collects feedback from users and provides the feedback to the AI analysis unit, thereby making it possible to improve selection accuracy of scents.

In this way, the present disclosure provides a relaxation system using scents in a nursing care facility, and can reduce stress of users and provide a comfortable environment. Specific examples of prompt sentences to be read by the generative AI include “Please tell me the components and their ratio for generating a scent having a relaxation effect” and “Please propose an optimal combination of scents for reducing stress of users”. Thereby, the AI can perform generation of a scent according to a user's request.

The system executes “emotion navigation” using the emotion maps shown in FIG. 9 and FIG. 10. Specifically, the current facial expression and voice tone of the user are detected using the camera 42 and the microphone 38B of the smart device 14 or the robot 414, and the user's current emotion (e.g., ANGER) is identified using the emotion identification model 59. Next, the system selects an optimal “scent” from the database to guide the user to a target emotion (e.g., JOY).

In this selection process, the AI system refers to the past user history (which scent changed the emotion to what extent) and optimizes the parameters for scent generation using Reinforcement Learning. This realizes a closed-loop Human-Machine Interface (HMI) that controls the environment by taking biological information called the user's mental state (Mental State) as input and outputting a physical scent, rather than simply emitting a scent.

### System Configuration

The system according to the present embodiment includes a sensor unit, a communication unit, an AI analysis unit, a generation unit, and a user interface unit.

The sensor unit is installed in each room or common space in the facility and includes a high-sensitivity sensor for detecting a volatile organic compound. This sensor can use technologies such as, for example, a semiconductor gas sensor, an optical sensor, and a mass spectrometry sensor. Thereby, it is possible to detect trace chemical substances in the air in the facility in real time. Specifically, it is possible to select a scent of lavender having a relaxation effect during a time zone when users take a nap, and select a citrus-based scent that stimulates appetite during a meal time zone. Also, it is possible to select an optimal scent by combining data such as temperature and humidity in the facility, and heart rate and activity amount of users. Furthermore, the sensor unit has a function of accumulating and analyzing past data in order to support selection of a scent according to individual needs of users.

The communication unit plays a role of transmitting data detected by the sensor unit to the AI analysis unit of the server. This communication unit can transmit data quickly and reliably using wireless communication technology such as Wi-Fi or Bluetooth. For example, data detected by the sensor unit can be transmitted to the AI analysis unit on the cloud utilizing a Wi-Fi network in a home. Also, it is possible to perform data transfer at a short distance using Bluetooth. Furthermore, the communication unit includes encryption and authentication functions for data, and secures security of transmitted data. Thereby, accurate transmission of data becomes possible while protecting privacy of users.

The AI analysis unit is arranged on the server and analyzes chemical component data transmitted from the communication unit. This AI analysis unit uses a machine learning algorithm to compare data with an existing scent database and identifies a profile of a scent in detail. For example, it can analyze chemical characteristics of various scents such as a scent of a flower, a scent of a fruit, a scent of a spice, a scent of wood, and further an artificial scent by utilizing deep learning technology. The AI analysis unit identifies a specific scent based on these data and analyzes its component composition. Specifically, when identifying a scent of a rose, it is possible to identify a combination of a specific floral component and a component having sweetness. Also, the AI analysis unit can consider selection history of past scents and preferences of users, and propose an optimal scent for each individual user. Specific examples of prompt sentences to be read by the generative AI include “Please tell me the components and their ratio for generating a scent having a relaxation effect” and “Please propose an optimal combination of scents for reducing stress of users”.

The generation unit is mounted on the terminal and reproduces a specific scent based on the profile of the scent identified by the AI analysis unit. This generation unit includes a cartridge containing a plurality of scent components, mixes the components in an appropriate ratio in accordance with an instruction of the AI, and can generate a scent. For example, when reproducing a scent of a rose, a scent desired by a user can be generated by mixing a specific floral component and a component having sweetness in an appropriate ratio. The generation unit releases the scent by heating or vaporizing a liquid or solid scent component. At this time, in order to adjust intensity or duration of the scent, concentration or vaporization speed of the component can be controlled. Furthermore, the generation unit can cooperate with an air conditioning system in the facility to diffuse the scent efficiently.

The user interface unit is mounted on the terminal and realized as a smartphone application. This application provides an interface for staff of the facility to perform selection of a scent and setting of generation timing. The staff can control generation of a scent in accordance with a state of a user or a situation in the facility. For example, it is possible to set a schedule to generate a scent in accordance with a time zone when a user feels like relaxing, or adjust the intensity of the scent to change concentration of the scent spreading in the facility. Also, the interface can record a history of scents and make a proposal of a new scent based on a user's preference or past selection. Furthermore, the application collects feedback from users and provides the feedback to the AI analysis unit, thereby making it possible to improve selection accuracy of scents.

In this way, the system according to the present embodiment realizes relaxation using scents in a nursing care facility, and can reduce stress of users and provide a comfortable environment.

### Implementation Steps

### Step 1: Detection of Scent

Detection of a scent is performed by the sensor unit installed in the facility. This sensor unit includes a high-sensitivity sensor for detecting a volatile organic compound, and for example, a semiconductor gas sensor or an optical sensor can be used. Thereby, it is possible to detect trace chemical substances in the air in the facility in real time. Specifically, it is possible to select a scent of lavender having a relaxation effect during a time zone when users take a nap, and select a citrus-based scent that stimulates appetite during a meal time zone. Also, it is possible to select an optimal scent by combining data such as temperature and humidity in the facility, and heart rate and activity amount of users.

### Step 2: Transmission of Data

Detected chemical component data is transmitted to the AI analysis unit of the server via the communication unit. This communication unit transmits data quickly and reliably using wireless communication technology such as Wi-Fi or Bluetooth. For example, data detected by the sensor unit can be transmitted to the AI analysis unit on the cloud utilizing a Wi-Fi network in a home. The communication unit includes encryption and authentication functions for data, and secures security of transmitted data. Thereby, accurate transmission of data becomes possible while protecting privacy of users.

### Step 3: Analysis of Scent

The AI analysis unit on the server analyzes the chemical component data transmitted from the communication unit. This AI analysis unit uses a machine learning algorithm to compare data with an existing scent database and identifies a profile of a scent in detail. For example, it can analyze chemical characteristics of various scents such as a scent of a flower, a scent of a fruit, a scent of a spice, a scent of wood, and further an artificial scent by utilizing deep learning technology. Specific examples of prompt sentences to be read by the generative AI include “Please tell me the components and their ratio for generating a scent having a relaxation effect” and “Please propose an optimal combination of scents for reducing stress of users”.

### Step 4: Generation of Scent

The generation unit reproduces a specific scent based on the profile of the scent identified by the AI analysis unit. This generation unit includes a cartridge containing a plurality of scent components, mixes the components in an appropriate ratio in accordance with an instruction of the AI, and can generate a scent. For example, when reproducing a scent of a rose, a scent desired by a user can be generated by mixing a specific floral component and a component having sweetness in an appropriate ratio. The generation unit releases the scent by heating or vaporizing a liquid or solid scent component. At this time, in order to adjust intensity or duration of the scent, concentration or vaporization speed of the component can be controlled.

### Step 5: Control by User

The user interface unit provides an interface for staff of the facility to perform selection of a scent and setting of generation timing. The staff can control generation of a scent in accordance with a state of a user or a situation in the facility. For example, it is possible to set a schedule to generate a scent in accordance with a time zone when a user feels like relaxing, or adjust the intensity of the scent to change concentration of the scent spreading in the facility. Also, the interface can record a history of scents and make a proposal of a new scent based on a user's preference or past selection. Furthermore, the application collects feedback from users and provides the feedback to the AI analysis unit, thereby making it possible to improve selection accuracy of scents.

### Specific Use Case

For example, consider a case where provision of scents aimed at relaxation of users is performed in a certain nursing care facility. In this facility, the sensor unit is installed in each room and common space, and thereby it is possible to detect volatile organic compounds in the air in real time. The sensor unit collects data for selecting an appropriate scent in accordance with activity status of users or an environment in the facility. For example, it is possible to select a scent of lavender having a relaxation effect during a time zone when users take a nap, and select a citrus-based scent that stimulates appetite during a meal time zone.

The communication unit transmits data detected by the sensor unit to the AI analysis unit of the server. This communication is performed utilizing a Wi-Fi network, and security is secured by encryption of data and an authentication function. The AI analysis unit compares the received data with the existing scent database in order to identify a scent optimal for a user based on the data. For example, when selecting a scent of lavender or chamomile having a relaxation effect, the AI analyzes components of these scents and generates an optimal profile. At this time, a specific example of a prompt sentence to be read by the generative AI includes “Please tell me the components and their ratio necessary to generate a scent of lavender for enhancing a relaxation effect”.

The generation unit mixes components necessary to reproduce the selected scent from the cartridge in an appropriate ratio based on an instruction from the AI analysis unit. The generation unit releases the scent by heating or vaporizing a liquid or solid scent component so that it spreads in the facility. Thereby, the user can spend time in a relaxed environment. For example, it is possible to combine and release scents of lavender and chamomile in order to promote sound sleep at night.

The user interface unit provides an interface for staff of the facility to perform selection of a scent and setting of generation timing. The staff can control generation of a scent in accordance with a state of a user or a situation in the facility. For example, it is possible to set a schedule to generate a scent in accordance with a time zone when a user feels like relaxing, or adjust the intensity of the scent to change concentration of the scent spreading in the facility. Also, the interface can record a history of scents and make a proposal of a new scent based on a user's preference or past selection.

In this way, the relaxation system using scents in a nursing care facility can reduce stress of users and provide a comfortable environment. Specific examples of prompt sentences to be read by the generative AI include “Please propose an optimal combination of scents for reducing stress of users” and “Please perform component adjustment for generating a scent for promoting sound sleep at night”. Thereby, the AI can perform generation of a scent according to a user's request.

The specific processing unit 290 transmits a result of the specific processing to the smart device 14. In the smart device 14, the control unit 46A causes the output device 40 to output the result of the specific processing. The microphone 38B acquires audio indicating a user input with respect to the result of the specific processing. The control unit 46A transmits audio data indicating the user input acquired by the microphone 38B to the data processing apparatus 12. In the data processing apparatus 12, the specific processing unit 290 acquires the audio data.

The data generation model 58 is a so-called generative AI (Artificial Intelligence). Examples of the data generation model 58 include generative AI such as ChatGPT (Registered Trademark) (Internet Search <URL: https://openai.com/blog/chatgpt>), etc. The data generation model 58 is obtained by causing a neural network to perform deep learning. A prompt including an instruction is input to the data generation model 58, and inference data such as audio data indicating audio, text data indicating text, and image data indicating an image (for example, still image data or moving image data) is input. The data generation model 58 infers the input inference data in accordance with the instruction indicated by the prompt, and outputs an inference result in a data format of one or more of audio data, text data, and image data, etc. The data generation model 58 includes, for example, text generation AI, image generation AI, multimodal generation AI, and the like. Here, inference refers to, for example, analysis, classification, prediction, and/or summary, etc. The specific processing unit 290 performs the above-described specific processing while using the data generation model 58. The data generation model 58 may be a model fine-tuned so as to output an inference result from a prompt not including an instruction, and in this case, the data generation model 58 can output an inference result from a prompt not including an instruction. In the data processing apparatus 12 and the like, a plurality of types of data generation models 58 are included, and the data generation models 58 include AI other than generative AI. AI other than generative AI is, for example, linear regression, logistic regression, decision tree, random forest, support vector machine (SVM), k-means clustering, convolutional neural network (CNN), recurrent neural network (RNN), generative adversarial network (GAN), or naive Bayes, etc., and can perform various processing, but is not limited to such examples. Also, the AI may be an AI agent. Also, when the processing of each part described above is performed by AI, part or all of the processing is performed by AI, but it is not limited to such an example. Also, processing implemented by AI including generative AI may be replaced with rule-based processing, and rule-based processing may be replaced with processing implemented by AI including generative AI.

Also, the processing by the data processing system 10 described above is executed by the specific processing unit 290 of the data processing apparatus 12 or the control unit 46A of the smart device 14, but may be executed by the specific processing unit 290 of the data processing apparatus 12 and the control unit 46A of the smart device 14. Also, the specific processing unit 290 of the data processing apparatus 12 acquires or collects information necessary for processing from the smart device 14 or an external apparatus, etc., and the smart device 14 acquires or collects information necessary for processing from the data processing apparatus 12 or an external apparatus, etc.

For example, a collection unit is realized by the control unit 46A of the smart device 14 or the specific processing unit 290 of the data processing apparatus 12. For example, an acquisition unit acquires step count data using the camera 42 or the communication I/F 44 of the smart device 14, and the data is processed by the specific processing unit 290 of the data processing apparatus 12. For example, an analysis unit is realized by the specific processing unit 290 of the data processing apparatus 12, and analyzes data from the collection unit and the acquisition unit. For example, a generation unit is realized by the specific processing unit 290 of the data processing apparatus 12, and generates a cooking menu using generative AI. For example, a provision unit is realized by the output device 40 of the smart device 14 or the specific processing unit 290 of the data processing apparatus 12, and provides the generated cooking menu to a user. The correspondence relationship between each unit and the apparatus or control unit is not limited to the above-described example, and various changes are possible.

In the above embodiment, an example of a form in which specific processing is performed by the data processing apparatus 12 has been given, but the technology of the present disclosure is not limited to this, and specific processing may be performed by the smart device 14.

### Second Embodiment

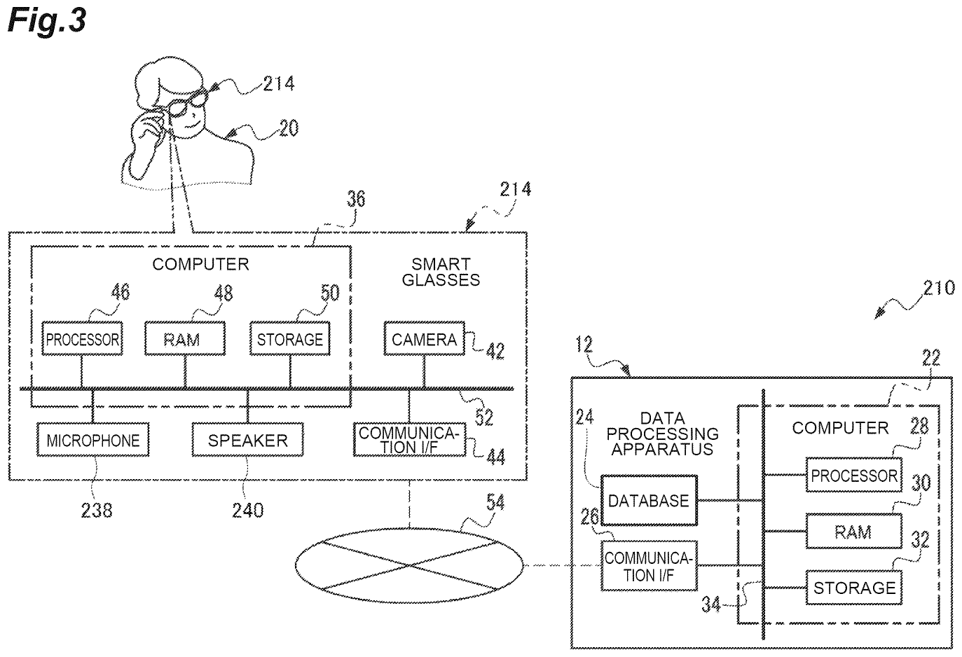

FIG. 3 shows an example of a configuration of a data processing system 210 according to a second embodiment.

As shown in FIG. 3, the data processing system 210 includes a data processing apparatus 12 and smart glasses 214. An example of the data processing apparatus 12 includes a server.

The data processing apparatus 12 includes a computer 22, a database 24, and a communication I/F 26. The computer 22 is an example of a “computer” according to the technology of the present disclosure. The computer 22 includes a processor 28, a RAM 30, and a storage 32. The processor 28, the RAM 30, and the storage 32 are connected to a bus 34. Also, the database 24 and the communication I/F 26 are also connected to the bus 34. The communication I/F 26 is connected to a network 54. Examples of the network 54 include a WAN (Wide Area Network) and/or a LAN (Local Area Network), and the like.

The smart glasses 214 include a computer 36, a microphone 238, a speaker 240, a camera 42, and a communication I/F 44. The computer 36 includes a processor 46, a RAM 48, and a storage 50. The processor 46, the RAM 48, and the storage 50 are connected to a bus 52. Also, the microphone 238, the speaker 240, and the camera 42 are also connected to the bus 52.

The microphone 238 receives an instruction or the like from a user 20 by receiving audio uttered by the user 20. The microphone 238 captures audio uttered by the user 20, converts the captured audio into audio data, and outputs it to the processor 46. The speaker 240 outputs audio in accordance with an instruction from the processor 46.

The camera 42 is a small digital camera on which an optical system such as a lens, a diaphragm, and a shutter, and an imaging element such as a CMOS (Complementary Metal-Oxide-Semiconductor) image sensor or a CCD (Charge Coupled Device) image sensor are mounted, and images surroundings of the user 20 (for example, an imaging range defined by an angle of view corresponding to a width of a field of view of a general healthy person).

The communication I/F 44 is connected to the network 54. The communication I/Fs 44 and 26 manage exchange of various information between the processor 46 and the processor 28 via the network 54. Exchange of various information between the processor 46 and the processor 28 using the communication I/Fs 44 and 26 is performed in a secure state.

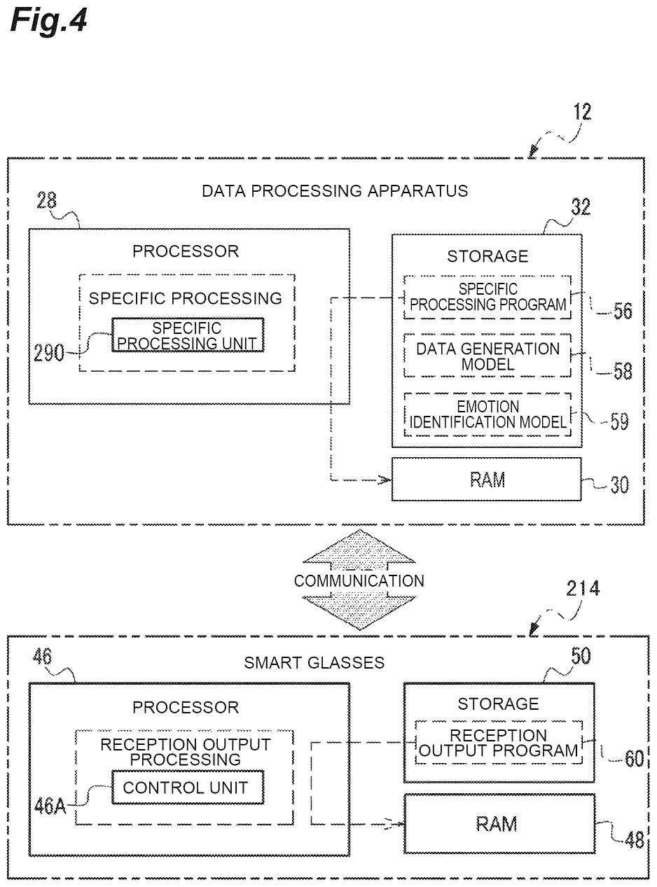

FIG. 4 shows an example of main functional parts of the data processing apparatus 12 and the smart glasses 214. As shown in FIG. 4, in the data processing apparatus 12, specific processing is performed by the processor 28. A specific processing program 56 is stored in the storage 32.

The specific processing program 56 is an example of a “program” according to the technology of the present disclosure. The processor 28 reads the specific processing program 56 from the storage 32 and executes the read specific processing program 56 on the RAM 30. The specific processing is realized by the processor 28 operating as the specific processing unit 290 in accordance with the specific processing program 56 executed on the RAM 30.

A data generation model 58 and an emotion identification model 59 are stored in the storage 32. The data generation model 58 and the emotion identification model 59 are used by the specific processing unit 290. The specific processing unit 290 can estimate an emotion of the user using the emotion identification model 59 and perform specific processing using the emotion of the user. In an emotion estimation function (emotion identification function) using the emotion identification model 59, various estimations and predictions regarding the emotion of the user, including estimation and prediction of the emotion of the user, are performed, but it is not limited to such an example. Also, the estimation and prediction of the emotion include, for example, analysis (analytics) of the emotion and the like.

In the smart glasses 214, reception output processing is performed by the processor 46. A reception output program 60 is stored in the storage 50. The processor 46 reads the reception output program 60 from the storage 50 and executes the read reception output program 60 on the RAM 48. The reception output processing is realized by the processor 46 operating as the control unit 46A in accordance with the reception output program 60 executed on the RAM 48. Note that the smart glasses 214 may have a data generation model and an emotion identification model similar to the data generation model 58 and the emotion identification model 59, and may perform processing similar to that of the specific processing unit 290 using these models.

Next, specific processing by the specific processing unit 290 of the data processing apparatus 12 will be described. Each part of the system described below is realized by the data processing apparatus 12 and the smart glasses 214. In the following description, the data processing apparatus 12 is referred to as a “server”, and the smart glasses 214 are referred to as a “terminal”.

### EXAMPLE 1

Since it is the same as the flow of specific processing in Example 1 described in the first embodiment, description thereof is omitted.

### APPLICATION EXAMPLE 1

Since it is the same as the flow of specific processing in Example 1 described in the first embodiment, description thereof is omitted.

The specific processing unit 290 transmits a result of the specific processing to the smart glasses 214. In the smart glasses 214, the control unit 46A causes the speaker 240 to output the result of the specific processing. The microphone 238 acquires audio indicating a user input with respect to the result of the specific processing. The control unit 46A transmits audio data indicating the user input acquired by the microphone 238 to the data processing apparatus 12. In the data processing apparatus 12, the specific processing unit 290 acquires the audio data.

The data generation model 58 is a so-called generative AI (Artificial Intelligence). Examples of the data generation model 58 include generative AI such as ChatGPT (Registered Trademark) (Internet Search <URL: https://openai.com/blog/chatgpt>), etc. The data generation model 58 is obtained by causing a neural network to perform deep learning. A prompt including an instruction is input to the data generation model 58, and inference data such as audio data indicating audio, text data indicating text, and image data indicating an image (for example, still image data or moving image data) is input. The data generation model 58 infers the input inference data in accordance with the instruction indicated by the prompt, and outputs an inference result in a data format of one or more of audio data, text data, and image data, etc. The data generation model 58 includes, for example, text generation AI, image generation AI, multimodal generation AI, and the like. Here, inference refers to, for example, analysis, classification, prediction, and/or summary, etc. The specific processing unit 290 performs the above-described specific processing while using the data generation model 58. The data generation model 58 may be a model fine-tuned so as to output an inference result from a prompt not including an instruction, and in this case, the data generation model 58 can output an inference result from a prompt not including an instruction. In the data processing apparatus 12 and the like, a plurality of types of data generation models 58 are included, and the data generation models 58 include AI other than generative AI. AI other than generative AI is, for example, linear regression, logistic regression, decision tree, random forest, support vector machine (SVM), k-means clustering, convolutional neural network (CNN), recurrent neural network (RNN), generative adversarial network (GAN), or naive Bayes, etc., and can perform various processing, but is not limited to such examples. Also, the AI may be an AI agent. Also, when the processing of each part described above is performed by AI, part or all of the processing is performed by AI, but it is not limited to such an example. Also, processing implemented by AI including generative AI may be replaced with rule-based processing, and rule-based processing may be replaced with processing implemented by AI including generative AI.

Also, the processing by the data processing system 10 described above is executed by the specific processing unit 290 of the data processing apparatus 12 or the control unit 46A of the smart device 14, but may be executed by the specific processing unit 290 of the data processing apparatus 12 and the control unit 46A of the smart device 14. Also, the specific processing unit 290 of the data processing apparatus 12 acquires or collects information necessary for processing from the smart device 14 or an external apparatus, etc., and the smart device 14 acquires or collects information necessary for processing from the data processing apparatus 12 or an external apparatus, etc.

For example, a collection unit is realized by the control unit 46A of the smart device 14 or the specific processing unit 290 of the data processing apparatus 12. For example, an acquisition unit acquires step count data using the camera 42 or the communication I/F 44 of the smart device 14, and the data is processed by the specific processing unit 290 of the data processing apparatus 12. For example, an analysis unit is realized by the specific processing unit 290 of the data processing apparatus 12, and analyzes data from the collection unit and the acquisition unit. For example, a generation unit is realized by the specific processing unit 290 of the data processing apparatus 12, and generates a cooking menu using generative AI. For example, a provision unit is realized by the output device 40 of the smart device 14 or the specific processing unit 290 of the data processing apparatus 12, and provides the generated cooking menu to a user. The correspondence relationship between each unit and the apparatus or control unit is not limited to the above-described example, and various changes are possible.

In the above embodiment, an example of a form in which specific processing is performed by the data processing apparatus 12 has been given, but the technology of the present disclosure is not limited to this, and specific processing may be performed by the smart glasses 214.

### Third Embodiment

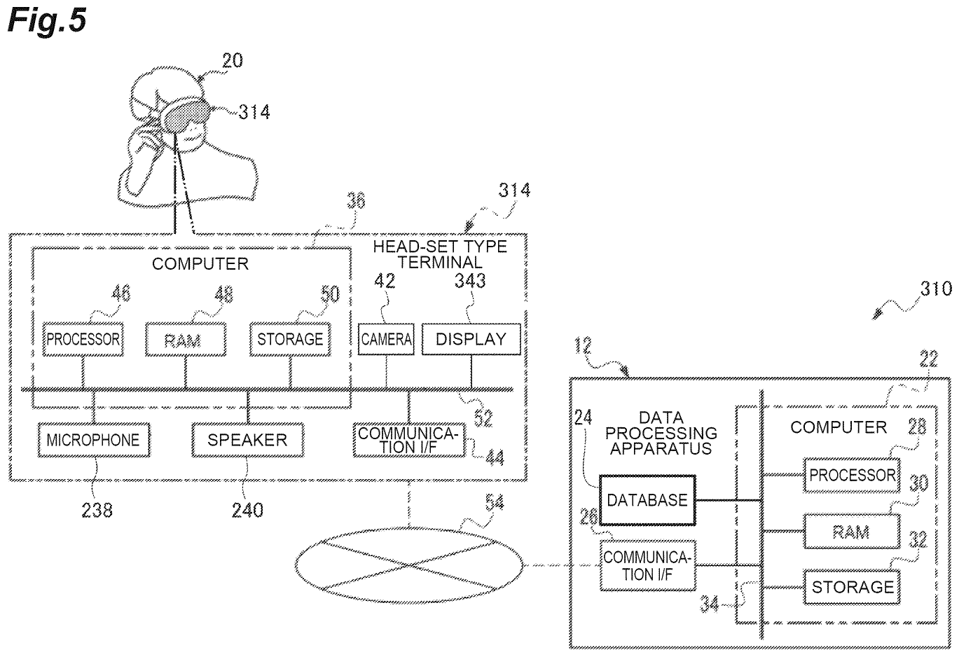

FIG. 5 shows an example of a configuration of a data processing system 310 according to a third embodiment.

As shown in FIG. 5, the data processing system 310 includes a data processing apparatus 12 and a headset-type terminal 314. An example of the data processing apparatus 12 includes a server.

The data processing apparatus 12 includes a computer 22, a database 24, and a communication I/F 26. The computer 22 is an example of a “computer” according to the technology of the present disclosure. The computer 22 includes a processor 28, a RAM 30, and a storage 32. The processor 28, the RAM 30, and the storage 32 are connected to a bus 34. Also, the database 24 and the communication I/F 26 are also connected to the bus 34. The communication I/F 26 is connected to a network 54. Examples of the network 54 include a WAN (Wide Area Network) and/or a LAN (Local Area Network), and the like.

The headset-type terminal 314 includes a computer 36, a microphone 238, a speaker 240, a camera 42, a communication I/F 44, and a display 343. The computer 36 includes a processor 46, a RAM 48, and a storage 50. The processor 46, the RAM 48, and the storage 50 are connected to a bus 52. Also, the microphone 238, the speaker 240, the camera 42, and the display 343 are also connected to the bus 52.

The microphone 238 receives an instruction or the like from a user 20 by receiving audio uttered by the user 20. The microphone 238 captures audio uttered by the user 20, converts the captured audio into audio data, and outputs it to the processor 46. The speaker 240 outputs audio in accordance with an instruction from the processor 46.

The camera 42 is a small digital camera on which an optical system such as a lens, a diaphragm, and a shutter, and an imaging element such as a CMOS (Complementary Metal-Oxide-Semiconductor) image sensor or a CCD (Charge Coupled Device) image sensor are mounted, and images surroundings of the user 20 (for example, an imaging range defined by an angle of view corresponding to a width of a field of view of a general healthy person).

The communication I/F 44 is connected to the network 54. The communication I/Fs 44 and 26 manage exchange of various information between the processor 46 and the processor 28 via the network 54. Exchange of various information between the processor 46 and the processor 28 using the communication I/Fs 44 and 26 is performed in a secure state.

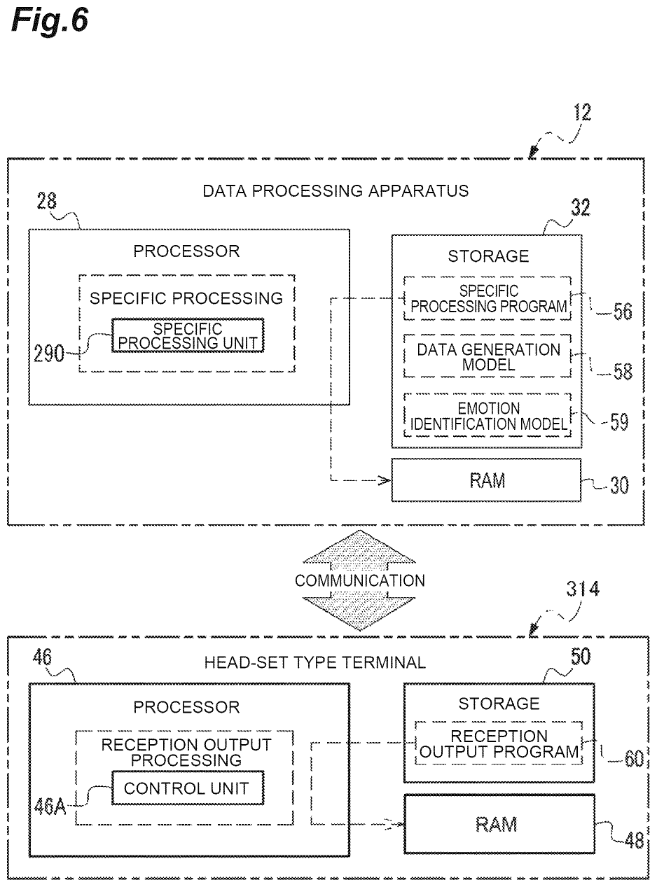

FIG. 6 shows an example of main functional parts of the data processing apparatus 12 and the headset-type terminal 314. As shown in FIG. 6, in the data processing apparatus 12, specific processing is performed by the processor 28. A specific processing program 56 is stored in the storage 32.

The specific processing program 56 is an example of a “program” according to the technology of the present disclosure. The processor 28 reads the specific processing program 56 from the storage 32 and executes the read specific processing program 56 on the RAM 30. The specific processing is realized by the processor 28 operating as the specific processing unit 290 in accordance with the specific processing program 56 executed on the RAM 30.

A data generation model 58 and an emotion identification model 59 are stored in the storage 32. The data generation model 58 and the emotion identification model 59 are used by the specific processing unit 290.

In the headset-type terminal 314, reception output processing is performed by the processor 46. A reception output program 60 is stored in the storage 50. The processor 46 reads the reception output program 60 from the storage 50 and executes the read reception output program 60 on the RAM 48. The reception output processing is realized by the processor 46 operating as the control unit 46A in accordance with the reception output program 60 executed on the RAM 48.

Next, specific processing by the specific processing unit 290 of the data processing apparatus 12 will be described. Each part of the system described below is realized by the data processing apparatus 12 and the headset-type terminal 314. In the following description, the data processing apparatus 12 is referred to as a “server”, and the headset-type terminal 314 is referred to as a “terminal”.

### EXAMPLE 1

Since it is the same as the flow of specific processing in Example 1 described in the first embodiment, description thereof is omitted.

### APPLICATION EXAMPLE 1

Since it is the same as the flow of specific processing in Example 1 described in the first embodiment, description thereof is omitted.

The specific processing unit 290 transmits a result of the specific processing to the headset-type terminal 314. In the headset-type terminal 314, the control unit 46A causes the speaker 240 and the display 343 to output the result of the specific processing. The microphone 238 acquires audio indicating a user input with respect to the result of the specific processing. The control unit 46A transmits audio data indicating the user input acquired by the microphone 238 to the data processing apparatus 12. In the data processing apparatus 12, the specific processing unit 290 acquires the audio data.

The data generation model 58 is a so-called generative AI (Artificial Intelligence). Examples of the data generation model 58 include generative AI such as ChatGPT (Registered Trademark) (Internet Search <URL: https://openai.com/blog/chatgpt>), etc. The data generation model 58 is obtained by causing a neural network to perform deep learning. A prompt including an instruction is input to the data generation model 58, and inference data such as audio data indicating audio, text data indicating text, and image data indicating an image (for example, still image data or moving image data) is input. The data generation model 58 infers the input inference data in accordance with the instruction indicated by the prompt, and outputs an inference result in a data format of one or more of audio data, text data, and image data, etc. The data generation model 58 includes, for example, text generation AI, image generation AI, multimodal generation AI, and the like. Here, inference refers to, for example, analysis, classification, prediction, and/or summary, etc. The specific processing unit 290 performs the above-described specific processing while using the data generation model 58. The data generation model 58 may be a model fine-tuned so as to output an inference result from a prompt not including an instruction, and in this case, the data generation model 58 can output an inference result from a prompt not including an instruction. In the data processing apparatus 12 and the like, a plurality of types of data generation models 58 are included, and the data generation models 58 include AI other than generative AI. AI other than generative AI is, for example, linear regression, logistic regression, decision tree, random forest, support vector machine (SVM), k-means clustering, convolutional neural network (CNN), recurrent neural network (RNN), generative adversarial network (GAN), or naive Bayes, etc., and can perform various processing, but is not limited to such examples. Also, the AI may be an AI agent. Also, when the processing of each part described above is performed by AI, part or all of the processing is performed by AI, but it is not limited to such an example. Also, processing implemented by AI including generative AI may be replaced with rule-based processing, and rule-based processing may be replaced with processing implemented by AI including generative AI.

Also, the processing by the data processing system 10 described above is executed by the specific processing unit 290 of the data processing apparatus 12 or the control unit 46A of the smart device 14, but may be executed by the specific processing unit 290 of the data processing apparatus 12 and the control unit 46A of the smart device 14. Also, the specific processing unit 290 of the data processing apparatus 12 acquires or collects information necessary for processing from the smart device 14 or an external apparatus, etc., and the smart device 14 acquires or collects information necessary for processing from the data processing apparatus 12 or an external apparatus, etc.

For example, a collection unit is realized by the control unit 46A of the smart device 14 or the specific processing unit 290 of the data processing apparatus 12. For example, an acquisition unit acquires step count data using the camera 42 or the communication I/F 44 of the smart device 14, and the data is processed by the specific processing unit 290 of the data processing apparatus 12. For example, an analysis unit is realized by the specific processing unit 290 of the data processing apparatus 12, and analyzes data from the collection unit and the acquisition unit. For example, a generation unit is realized by the specific processing unit 290 of the data processing apparatus 12, and generates a cooking menu using generative AI. For example, a provision unit is realized by the output device 40 of the smart device 14 or the specific processing unit 290 of the data processing apparatus 12, and provides the generated cooking menu to a user. The correspondence relationship between each unit and the apparatus or control unit is not limited to the above-described example, and various changes are possible.

In the above embodiment, an example of a form in which specific processing is performed by the data processing apparatus 12 has been given, but the technology of the present disclosure is not limited to this, and specific processing may be performed by the headset-type terminal 314.

### Fourth Embodiment

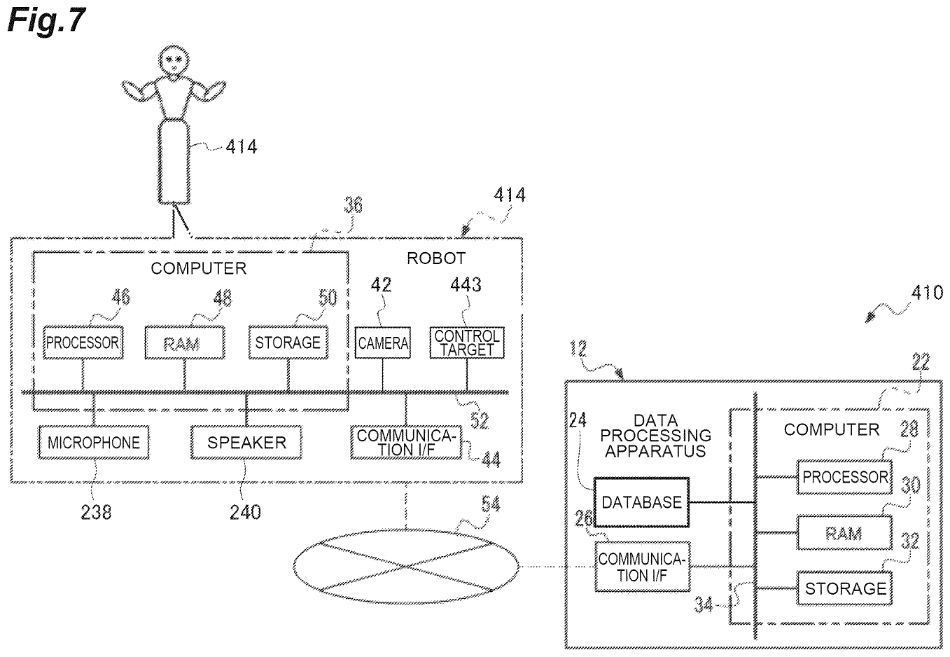

FIG. 7 shows an example of a configuration of a data processing system 410 according to a fourth embodiment.

As shown in FIG. 7, the data processing system 410 includes a data processing apparatus 12 and a robot 414. An example of the data processing apparatus 12 includes a server.

The data processing apparatus 12 includes a computer 22, a database 24, and a communication I/F 26. The computer 22 is an example of a “computer” according to the technology of the present disclosure. The computer 22 includes a processor 28, a RAM 30, and a storage 32. The processor 28, the RAM 30, and the storage 32 are connected to a bus 34. Also, the database 24 and the communication I/F 26 are also connected to the bus 34. The communication I/F 26 is connected to a network 54. Examples of the network 54 include a WAN (Wide Area Network) and/or a LAN (Local Area Network), and the like.

The robot 414 includes a computer 36, a microphone 238, a speaker 240, a camera 42, a communication I/F 44, and a control target 443. The computer 36 includes a processor 46, a RAM 48, and a storage 50. The processor 46, the RAM 48, and the storage 50 are connected to a bus 52. Also, the microphone 238, the speaker 240, the camera 42, and the control target 443 are also connected to the bus 52.

The microphone 238 receives an instruction or the like from a user 20 by receiving audio uttered by the user 20. The microphone 238 captures audio uttered by the user 20, converts the captured audio into audio data, and outputs it to the processor 46. The speaker 240 outputs audio in accordance with an instruction from the processor 46.

The camera 42 is a small digital camera on which an optical system such as a lens, a diaphragm, and a shutter, and an imaging element such as a CMOS (Complementary Metal-Oxide-Semiconductor) image sensor or a CCD (Charge Coupled Device) image sensor are mounted, and images surroundings of the user 20 (for example, an imaging range defined by an angle of view corresponding to a width of a field of view of a general healthy person).

The communication I/F 44 is connected to the network 54. The communication I/Fs 44 and 26 manage exchange of various information between the processor 46 and the processor 28 via the network 54. Exchange of various information between the processor 46 and the processor 28 using the communication I/Fs 44 and 26 is performed in a secure state.

The control target 443 includes a display device, an LED of an eye part, and a motor for driving an arm, a hand, a leg, and the like. A posture and a gesture of the robot 414 are controlled by controlling motors of the arm, the hand, the leg, and the like. Part of emotions of the robot 414 can be expressed by controlling these motors. Also, an expression of the robot 414 can be expressed by controlling a light emission state of the LED of the eye part of the robot 414.

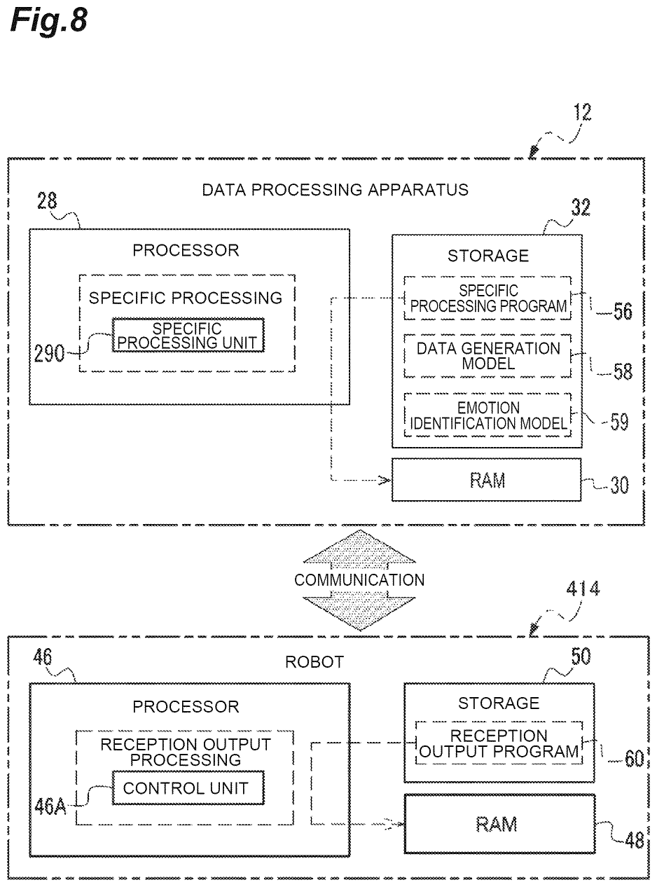

FIG. 8 shows an example of main functional parts of the data processing apparatus 12 and the robot 414. As shown in FIG. 8, in the data processing apparatus 12, specific processing is performed by the processor 28. A specific processing program 56 is stored in the storage 32.

The specific processing program 56 is an example of a “program” according to the technology of the present disclosure. The processor 28 reads the specific processing program 56 from the storage 32 and executes the read specific processing program 56 on the RAM 30. The specific processing is realized by the processor 28 operating as the specific processing unit 290 in accordance with the specific processing program 56 executed on the RAM 30.

A data generation model 58 and an emotion identification model 59 are stored in the storage 32. The data generation model 58 and the emotion identification model 59 are used by the specific processing unit 290.

In the robot 414, reception output processing is performed by the processor 46. A reception output program 60 is stored in the storage 50. The processor 46 reads the reception output program 60 from the storage 50 and executes the read reception output program 60 on the RAM 48. The reception output processing is realized by the processor 46 operating as the control unit 46A in accordance with the reception output program 60 executed on the RAM 48.

Next, specific processing by the specific processing unit 290 of the data processing apparatus 12 will be described. Each part of the system described below is realized by the data processing apparatus 12 and the robot 414. In the following description, the data processing apparatus 12 is referred to as a “server”, and the robot 414 is referred to as a “terminal”.

### EXAMPLE 1

Since it is the same as the flow of specific processing in Example 1 described in the first embodiment, description thereof is omitted.

### APPLICATION EXAMPLE 1

Since it is the same as the flow of specific processing in Example 1 described in the first embodiment, description thereof is omitted.

The specific processing unit 290 transmits a result of the specific processing to the robot 414. In the robot 414, the control unit 46A causes the speaker 240 and the control target 443 to output the result of the specific processing. The microphone 238 acquires audio indicating a user input with respect to the result of the specific processing. The control unit 46A transmits audio data indicating the user input acquired by the microphone 238 to the data processing apparatus 12. In the data processing apparatus 12, the specific processing unit 290 acquires the audio data.

The data generation model 58 is a so-called generative AI (Artificial Intelligence). Examples of the data generation model 58 include generative AI such as ChatGPT (Registered Trademark) (Internet Search <URL: https://openai.com/blog/chatgpt>), etc. The data generation model 58 is obtained by causing a neural network to perform deep learning. A prompt including an instruction is input to the data generation model 58, and inference data such as audio data indicating audio, text data indicating text, and image data indicating an image (for example, still image data or moving image data) is input. The data generation model 58 infers the input inference data in accordance with the instruction indicated by the prompt, and outputs an inference result in a data format of one or more of audio data, text data, and image data, etc. The data generation model 58 includes, for example, text generation AI, image generation AI, multimodal generation AI, and the like. Here, inference refers to, for example, analysis, classification, prediction, and/or summary, etc. The specific processing unit 290 performs the above-described specific processing while using the data generation model 58. The data generation model 58 may be a model fine-tuned so as to output an inference result from a prompt not including an instruction, and in this case, the data generation model 58 can output an inference result from a prompt not including an instruction. In the data processing apparatus 12 and the like, a plurality of types of data generation models 58 are included, and the data generation models 58 include AI other than generative AI. AI other than generative AI is, for example, linear regression, logistic regression, decision tree, random forest, support vector machine (SVM), k-means clustering, convolutional neural network (CNN), recurrent neural network (RNN), generative adversarial network (GAN), or naive Bayes, etc., and can perform various processing, but is not limited to such examples. Also, the AI may be an AI agent. Also, when the processing of each part described above is performed by AI, part or all of the processing is performed by AI, but it is not limited to such an example. Also, processing implemented by AI including generative AI may be replaced with rule-based processing, and rule-based processing may be replaced with processing implemented by AI including generative AI.

Also, the processing by the data processing system 10 described above is executed by the specific processing unit 290 of the data processing apparatus 12 or the control unit 46A of the smart device 14, but may be executed by the specific processing unit 290 of the data processing apparatus 12 and the control unit 46A of the smart device 14. Also, the specific processing unit 290 of the data processing apparatus 12 acquires or collects information necessary for processing from the smart device 14 or an external apparatus, etc., and the smart device 14 acquires or collects information necessary for processing from the data processing apparatus 12 or an external apparatus, etc.

For example, a collection unit is realized by the control unit 46A of the smart device 14 or the specific processing unit 290 of the data processing apparatus 12. For example, an acquisition unit acquires step count data using the camera 42 or the communication I/F 44 of the smart device 14, and the data is processed by the specific processing unit 290 of the data processing apparatus 12. For example, an analysis unit is realized by the specific processing unit 290 of the data processing apparatus 12, and analyzes data from the collection unit and the acquisition unit. For example, a generation unit is realized by the specific processing unit 290 of the data processing apparatus 12, and generates a cooking menu using generative AI. For example, a provision unit is realized by the output device 40 of the smart device 14 or the specific processing unit 290 of the data processing apparatus 12, and provides the generated cooking menu to a user. The correspondence relationship between each unit and the apparatus or control unit is not limited to the above-described example, and various changes are possible.

In the above embodiment, an example of a form in which specific processing is performed by the data processing apparatus 12 has been given, but the technology of the present disclosure is not limited to this, and specific processing may be performed by the robot 414.

Note that the emotion identification model 59 as an emotion engine may determine an emotion of a user in accordance with a specific mapping. Specifically, the emotion identification model 59 may determine an emotion of a user in accordance with an emotion map (see FIG. 9) which is a specific mapping. Also, the emotion identification model 59 may similarly determine an emotion of the robot, and the specific processing unit 290 may perform specific processing using the emotion of the robot.

FIG. 9 is a diagram showing an emotion map 400 on which a plurality of emotions are mapped. In the emotion map 400, emotions are arranged radially in concentric circles from a center. Emotions in a primitive state are arranged closer to the center of the concentric circles. Emotions representing states and actions born from a mental state are arranged further outside the concentric circles. Emotion is a concept including affect and mental state. Emotions generated from reactions generally occurring in a brain are arranged on a left side of the concentric circles. Emotions induced by situational judgment are generally arranged on a right side of the concentric circles. Emotions generated from reactions generally occurring in a brain and induced by situational judgment are arranged in an upper direction and a lower direction of the concentric circles. Also, emotions of “pleasantness” are arranged on an upper side of the concentric circles, and emotions of “unpleasantness” are arranged on a lower side. In this way, in the emotion map 400, a plurality of emotions are mapped based on a structure in which emotions are born, and emotions that are likely to occur simultaneously are mapped close to each other.

These emotions are distributed in a direction of 3 o'clock of the emotion map 400, and usually go back and forth around relief and anxiety. In a right half of the emotion map 400, situational awareness is superior to internal sensation, so it gives a calm impression.

Since an inside of the emotion map 400 represents inside of a mind and an outside of the emotion map 400 represents an action, an emotion becomes visible (appears in an action) as it goes to the outside of the emotion map 400.

Here, human emotions are based on various balances such as posture and blood sugar level, and show a state of unpleasantness when those balances move away from an ideal, and pleasantness when they approach the ideal. Even in a robot, a car, a motorcycle, or the like, emotions can be created based on various balances such as posture and remaining battery level so as to show a state of unpleasantness when those balances move away from an ideal, and pleasantness when they approach the ideal. The emotion map may be generated based on, for example, Dr. Mitsuyoshi's emotion map (Research on Voice Emotion Recognition and Brain Physiological Signal Analysis System of Affect, Tokushima University, Doctoral Dissertation: https://ci.ni.ac.jp/naid/500000375379). Emotions belonging to a region called “reaction” where sensation is superior are lined up in a left half of the emotion map. Also, emotions belonging to a region called “situation” where situational awareness is superior are lined up in a right half of the emotion map.

Two emotions that encourage learning are defined in the emotion map. One is an emotion around a middle of negative “repentance” and “reflection” on the situation side. That is, it is when a negative emotion such as “I don't want to feel like this again” or “I don't want to be scolded anymore” occurs in the robot. The other is an emotion around positive “desire” on the reaction side. That is, it is when there is a positive feeling such as “I want more” or “I want to know more”.

The emotion identification model 59 inputs a user input to a pre-learned neural network, acquires an emotion value indicating each emotion shown in the emotion map 400, and determines an emotion of the user. This neural network is pre-learned based on a plurality of learning data which are combinations of user inputs and emotion values indicating each emotion shown in the emotion map 400. Also, this neural network is learned so that emotions arranged close to each other have close values, like an emotion map 900 shown in FIG. 10. FIG. 10 shows an example in which a plurality of emotions of “relief”, “tranquility”, and “reassuring” have close emotion values.

Although the system according to the present disclosure has been described above mainly with respect to the functions of the data processing apparatus 12, the system according to the present disclosure is not necessarily implemented in a server. The system according to the present disclosure may be implemented as a general information processing system. The present disclosure may be implemented as, for example, a software program operating on a personal computer, an application operating on a smartphone or the like. The method according to the present disclosure may be provided to a user in a SaaS (Software as a Service) format.

In the above embodiment, an example of a form in which specific processing is performed by one computer 22 has been given, but the technology of the present disclosure is not limited to this, and distributed processing for specific processing by a plurality of computers including the computer 22 may be performed. For example, the data generation model 58 may be provided in an external apparatus of the data processing apparatus 12, and generation of data according to input data may be performed in the external apparatus.

In the above embodiment, an example of a form in which the specific processing program 56 is stored in the storage 32 has been described, but the technology of the present disclosure is not limited to this. For example, the specific processing program 56 may be stored in a portable computer-readable non-transitory storage medium such as a USB (Universal Serial Bus) memory. The specific processing program 56 stored in the non-transitory storage medium is installed in the computer 22 of the data processing apparatus 12. The processor 28 executes specific processing in accordance with the specific processing program 56.

Also, the specific processing program 56 may be stored in a storage device such as a server connected to the data processing apparatus 12 via the network 54, and the specific processing program 56 may be downloaded in response to a request from the data processing apparatus 12 and installed in the computer 22.

Note that it is not necessary to store all of the specific processing program 56 in a storage device such as a server connected to the data processing apparatus 12 via the network 54, or to store all of the specific processing program 56 in the storage 32, and a part of the specific processing program 56 may be stored.

As hardware resources for executing specific processing, various processors shown below can be used. Examples of the processor include a CPU which is a general-purpose processor that functions as a hardware resource for executing specific processing by executing software, that is, a program. Also, examples of the processor include a dedicated electric circuit which is a processor having a circuit configuration specifically designed to execute specific processing, such as an FPGA (Field-Programmable Gate Array), a PLD (Programmable Logic Device), or an ASIC (Application Specific Integrated Circuit). A memory is built in or connected to any processor, and any processor executes specific processing by using the memory.

The hardware resource for executing specific processing may be configured by one of these various processors, or may be configured by a combination of two or more processors of the same type or different types (for example, a combination of a plurality of FPGAs, or a combination of a CPU and an FPGA). Also, the hardware resource for executing specific processing may be one processor.

As an example of configuring with one processor, first, there is a form in which one processor is configured by a combination of one or more CPUs and software, and this processor functions as a hardware resource for executing specific processing. Second, there is a form in which a processor that realizes functions of an entire system including a plurality of hardware resources for executing specific processing with one IC chip is used, as represented by SoC (System-on-a-chip) and the like. In this way, specific processing is realized using one or more of the above various processors as hardware resources.

Furthermore, as a hardware structure of these various processors, more specifically, an electric circuit combining circuit elements such as semiconductor elements can be used. Also, the above specific processing is merely an example. Therefore, it goes without saying that unnecessary steps may be deleted, new steps may be added, or processing order may be changed within a range not departing from the gist.

The description content and illustration content shown above are detailed descriptions of parts related to the technology of the present disclosure, and are merely examples of the technology of the present disclosure. For example, the description regarding the above configuration, function, action, and effect is description regarding an example of a configuration, function, action, and effect of a part related to the technology of the present disclosure. Therefore, it goes without saying that unnecessary parts may be deleted, new elements may be added, or replacements may be made to the description content and illustration content shown above within a range not departing from the gist of the technology of the present disclosure. Also, in order to avoid complication and facilitate understanding of parts related to the technology of the present disclosure, in the description content and illustration content shown above, description regarding common general technical knowledge and the like that does not require particular description for enabling implementation of the technology of the present disclosure is omitted.

All literatures, patent applications, and technical standards described in this specification are incorporated herein by reference to the same extent as if each individual literature, patent application, and technical standard was specifically and individually indicated to be incorporated by reference.

Regarding the above embodiments, the following is further disclosed.

### APPLICATION EXAMPLE 1

A system comprising a sensor unit, a communication unit, an AI analysis unit, a generation unit, and a user interface unit. The sensor unit includes a high-sensitivity sensor for detecting a volatile organic compound, and detects chemical components in air in a facility in real time. The communication unit transmits data detected by the sensor unit to the AI analysis unit of a server, and the AI analysis unit analyzes the data using a machine learning algorithm and identifies a profile of a scent. The generation unit mixes a plurality of scent components in an appropriate ratio based on the profile of the scent identified by the AI analysis unit, and generates a scent. The user interface unit enables selection of a scent and setting of generation timing through a smartphone application, and provides a scent experience according to a user's preference.

The system, wherein the sensor unit is installed in each room or common space in the facility, and has a function of collecting data for selecting an appropriate scent in accordance with activity status of a user or an environment in the facility. Specifically, it is possible to select a scent of lavender having a relaxation effect during a time zone when a user takes a nap, and select a citrus-based scent that stimulates appetite during a meal time zone.

The system, wherein the user interface unit provides an interface for staff of the facility to perform selection of a scent and setting of generation timing, and can control generation of a scent in accordance with a state of a user or a situation in the facility. Specifically, it is possible to set a schedule to generate a scent in accordance with a time zone when a user feels like relaxing, or adjust intensity of a scent to change concentration of the scent spreading in the facility.

A system for identifying and generating a scent, the system comprising: a sensor; circuitry; and a user interface, wherein the sensor is configured to detect a volatile organic compound, wherein the circuitry is configured to: transmit chemical component data obtained by detecting the volatile organic compound to an AI system on a cloud; and generate the scent based on a profile of the scent analyzed by the AI system, and wherein the user interface is configured to receive an input from a user for controlling selection and generation timing of the scent by the user.

The system, wherein the sensor is configured to convert the chemical component data obtained by detecting a chemical substance in air in real time into a digital signal, and wherein the circuitry is configured to transmit the digital signal to the AI system on the cloud via Wi-Fi or Bluetooth.

The system, further comprising: a cartridge containing a plurality of scent components, wherein the circuitry is configured to: instruct which component is to be mixed in what ratio based on the profile from the AI system; and generate the scent in accordance with the instruction, and wherein the user interface is configured to receive the input from the user for controlling the selection of the scent, the generation timing of the scent, and adjustment of scent intensity via a smartphone application.

A method for identifying and generating a scent using a system for identifying and generating a scent, the system comprising: a sensor; circuitry; and a user interface, the method comprising: detecting a volatile organic compound by the sensor; transmitting chemical component data obtained by the detecting the volatile organic compound to an AI system on a cloud; generating the scent based on a profile of the scent analyzed by the AI system; and receiving an input from a user for controlling selection and generation timing of the scent by the user via the user interface.

1. A system for identifying and generating a scent,
the system comprising:
a sensor;
circuitry; and
a user interface,
wherein the sensor is configured to detect a volatile organic compound,
wherein the circuitry is configured to:
transmit chemical component data obtained by detecting the volatile organic compound to an AI system on a cloud; and
generate the scent based on a profile of the scent analyzed by the AI system, and
wherein the user interface is configured to receive an input from a user for controlling selection and generation timing of the scent by the user.

2. The system according to claim 1,
wherein the sensor is configured to convert the chemical component data obtained by detecting a chemical substance in air in real time into a digital signal, and
wherein the circuitry is configured to transmit the digital signal to the AI system on the cloud via Wi-Fi or Bluetooth.

3. The system according to claim 1,
further comprising: a cartridge containing a plurality of scent components,
wherein the circuitry is configured to:
instruct which component is to be mixed in what ratio based on the profile from the AI system; and
generate the scent in accordance with the instruction, and wherein the user interface is configured to receive the input from the user for controlling the selection of the scent, the generation timing of the scent, and adjustment of scent intensity via a smartphone application.

4. A method for identifying and generating a scent using a system for identifying and generating a scent, the system comprising: a sensor; circuitry; and a user interface,
the method comprising:
detecting a volatile organic compound by the sensor;
transmitting chemical component data obtained by the detecting the volatile organic compound to an AI system on a cloud;
generating the scent based on a profile of the scent analyzed by the AI system; and
receiving an input from a user for controlling selection and generation timing of the scent by the user via the user interface.
